(19) United States
(12) Patent Application Publication
(10) Pub. No.: US 2017/0254108 A1
(43) Pub. Date: Sep. 7, 2017

(54) Decorative mosaic object and grout containing cremains

(71) Applicant: Susan P. Armstrong, Knoxville, TN (US)

(72) Inventor: Susan P. Armstrong, Knoxville, TN (US)

(21) Appl. No.: 14/998,905

(22) Filed: Mar. 2, 2016

(51) Int. Cl. E04H 13/00; C04B 28/14; C08K 11/00; C04B 14/36; C04B 28/04

(52) U.S. Cl. CPC E04H 13/008; C04B 14/36; C04B 28/04; C08K 11/00; C04B 28/14; C04B 2111/00525

(57) ABSTRACT

A decorative memorial object includes: a metal substrate having a bottom surface, a top surface, and a bezel surrounding the top surface and defining an area thereon; a plurality of mosaic pieces arranged within the area defined by the bezel and affixed to the top surface of the substrate; and, a grout material in the interstices between the individual mosaic pieces and between the mosaic pieces and the bezel, the grout material comprising a binder and a selected quantity of cremains of the individual being memorialized, so that the cremains are visible on the surface and form part of the mosaic design. The grout may include a cementitious material such as plaster of Paris, or may include a thermosetting polymer as the binder. A related method for making the decorative object is also disclosed.

### BACKGROUND OF THE INVENTION

Field of the Invention

The invention pertains to decorative objects containing cremated remains and methods for making them. More particularly, it pertains to the incorporation of cremains into a mortar or grout and the use of such grout for artistic purposes

Description of Related Art

Cremation is a widely-used alternative to burial, both for humans and for pets. The remains, or ashes, are often referred to as cremains, and various alternatives are available for the disposal, storage, or use of cremains. They may be scattered, or they may be placed in an urn or other container, which may be interred in a mausoleum, displayed in the home of a loved one, or otherwise stored. Several variations in urns and other memorial objects have been disclosed, including decorative urns for display in the home or elsewhere, as well as wearable items such as jewelry that contain a hollow space in which a small quantity of cremains will be placed.

U.S. Pat. No. 8,419,140 to Ward describes a lighted decorative cremation urn memorial constructed of rigid interlocking paneled materials used to house and display cremation urns and the personal effects of the decedent. A multi-chambered design allows for chamber areas to be aesthetically enhanced with the addition of cut stone and fabric inserts while outfitting other chambers with electronic imaging capability such as a liquid crystal display (LCD) picture screen with integrated functions and remote control. A user can utilize chamber areas to simultaneously display cremation urn(s), personal effects, and present electronic media. Certain chambers contain lighting systems, such as light emitting diode (LED) or other, where cremation urns and personal effects can be better accentuated. Added personalization includes the ability to engrave surfaces and affix engraved panels or emblems to suit the user.

U.S. Pat. No. 8,046,881 to Johnson et al. describes a cremation urn and a system for retaining cremation remains, the invention comprising in one embodiment, a top shelf, a bottom shelf and a middle portion defining an artwork channel, recess or void between the top and bottom shelves. In another embodiment, the bottom shelf and the top shelf have a larger surface area than the middle portion so that both the top and bottom shelf protrude further out away from the middle portion. In this regard, the middle portion can then be defined to have a channel of surface space between the top and bottom shelves, so that optional ornamental designs or artwork can be variously, sequentially or randomly coupled to the middle portion's viewable surface area within the artwork channel, recess or void. In another embodiment, the top shelf has a top surface which is adapted to receive and retain optional ornamental designs or artwork. In another embodiment, the artwork recess formed in the urn is covered by a protective sheet which is preferably transparent in nature, to thereby substantially or permanently encapsulate any artwork within the recess for viewing. An optional rotatable base for the urn is also disclosed.

U.S. Pat. No. 7,861,385 to Meyer describes a perpetual memorial or legacy card comprised of polycarbonate card having a small quantity of human cremains sealed within said card, and furthermore having graphical and textual material on the front and rear faces of the card, that can be carried in a pocket or wallet, with the card serving as a remembrance of the deceased.

U.S. Des. Pat. No. 608,238 to Warren et al. claims the ornamental design for a cremains jewelry item containing a hollow cavity into which the cremains are to be placed in powder form.

U.S. Pat. No. 7,562,423 to Pryd-Kakuk describes a personalizable memory container including a container portion having a cavity therein, a sealable capsule selectively disposable in the cavity, and mementos selectively presentable on reconfigurable spaces on the container portion. The mementos can conceal the capsule when the capsule is disposed in the cavity and when the mementos are selectively presented on the reconfigurable spaces.

Another approach is to incorporate the cremains into a fused mass of glass by conventional lampwork or glass blowing techniques. In this case, the customer supplies a small quantity of cremains and the glass artist produces the finished glass object.

### Objects and Advantages

Objects of the present invention include the following: providing a decorative object containing visible cremains; providing a durable object of jewelry in which cremains are part of the design elements; providing a kit that allows a user to create an artistic object using cremains of a loved one; providing a mosaic object in which cremains are incorporated into the grout component; and providing a convenient method for incorporating cremains into jewelry or other decorative items. These and other objects and advantages of the invention will become apparent from consideration of the following specification, read in conjunction with the drawings.

### SUMMARY OF THE INVENTION

According to one aspect of the invention, a decorative memorial item comprises:

a metal substrate having a bottom surface, a top surface, and a bezel surrounding the top surface;

a plurality of mosaic pieces arranged within the bezel and affixed to the top surface; and,

a grout material disposed in the interstices between the individual mosaic pieces and between the mosaic pieces and the bezel, the grout material comprising a binder and a selected quantity of cremains of the individual being memorialized, so that the cremains are visible on the surface and form part of the mosaic design.

According to another aspect of the invention, a decorative grout comprises:

a filler material of a selected color;

a binder phase; and,

a selected amount of cremains that will be visible on the surface after the grout has hardened.

According to another aspect of the invention, a method for making a decorative memorial item comprises the steps of:

forming a metal substrate into a selected shape, with a raised bezel around the periphery of a selected area thereon;

placing mosaic pieces in a selected arrangement within the area defined by the bezel;

fixedly attaching the mosaic pieces to the metal substrate in the selected arrangement;

making a grout mixture containing a binder, a filler, and a selected quantity of cremains of the subject being memorialized;

applying the grout mixture to fill the spaces between individual mosaic pieces and between the mosaic pieces and the raised bezel; and,

cleaning the finished mosaic to remove excess grout.

According to another aspect of the invention, a decorative memorial item comprises:

a substrate of a selected size and shape and having on one surface thereof a depression having a selected outline and further having a sufficient depth to accommodate a selected volume of grout material; and,

a decorative grout filling the depression, the grout comprising:
a filler material of a selected color;
a binder phase; and,
a selected amount of cremains that will be visible on the surface after the grout has hardened.

According to another aspect of the invention, a method for making a decorative memorial item comprises the steps of:

forming a metal substrate of a selected size and shape and having on one surface thereof a depression of a selected outline and further having a suitable depth to accommodate a selected volume of grout material;

making a grout mixture containing a binder, a filler, and a selected quantity of cremains of the subject being memorialized;

applying the grout mixture to fill the depression;

allowing the grout mixture to harden; and,

cleaning the finished item to remove excess grout.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIGS. 1A-B show a schematic diagram of one example of the present invention, in which glass or ceramic tiles or beads are attached with adhesive. The article is shown in plan view (FIG. 1A) and in magnified cross section along A-A (FIG. 1B).

FIG. 2 is a schematic diagram in cross section of another example of the invention, in which metal tiles are attached by braze or solder joints.

FIG. 3 is a schematic diagram in cross section of another example of the invention, in which three-dimensional surface relief is created by forming or stamping a metal sheet, and grout is applied to the low areas of the surface relief.

FIGS. 4A-D show a schematic diagram of another example of the invention, in which a substrate is provided with a recessed area of a selected shape, and the recessed area is filled in with grout containing cremains. FIGS. 4A and 4B show a substantially monolithic inlay in plan view and in cross section along A-A. FIGS. 4C and 4D show a similar overall inlay pattern, but made of narrower channels to contain the grout, in plan view and in cross section along B-B.

### DETAILED DESCRIPTION OF THE INVENTION

In its most general sense, the invention involves the incorporation of cremains into a grout mixture in such a way that at least some of the cremains will be visible on the surface of the finished grout, while at the same time preserving an acceptable level of strength and workability of the grout. One preferred example involves a piece of jewelry or similar decorative item in the form of a mosaic having discrete mosaic pieces or tiles, with the inventive grout placed between the mosaic pieces and thereby forming part of the overall aesthetic effect. Other preferred examples involve using the inventive grout in an inlay pattern.

It will be appreciated that, as used herein, cremains refers to the ash or residue of a human or animal that has been cremated. The term user may include a loved one wishing to preserve the cremains of a spouse, relative, or pet; it may also include a service provider such as a funeral director, veterinarian, artist, or other professional who might be preparing an object on behalf of the loved one.

The invention is particularly suited to producing various types of mosaic art. It will be appreciated that as used herein, “mosaic” is defined as any object having a number of discrete pieces that are attached to a substrate, with a grout applied to fill in the gaps between the pieces. The pieces may be small ceramic tiles, beads, flattened lumps of glass, lapidary materials or gemstones, metal tiles, small shells or coral, or any combination of such items. The pieces may be of uniform size and shape, such as small ceramic squares, or they may be various sizes and shapes. The pieces may be attached to the substrate using a suitable adhesive, such as epoxy or other glue. If the pieces are metal, they may be attached to the substrate by brazing or soldering.

Alternatively, a “mosaic effect” may be achieved by forming, stamping, or embossing a thin metal sheet to create a pattern of discrete raised areas, separated from one another by channels into which the grout may be placed.

The following examples will provide a fuller understanding of the invention and some ways in which it can be produced and used. Applicant does not intend for the invention to be limited to the particular exemplary descriptions, but rather the scope of the invention is defined in the appended claims.

### EXAMPLE

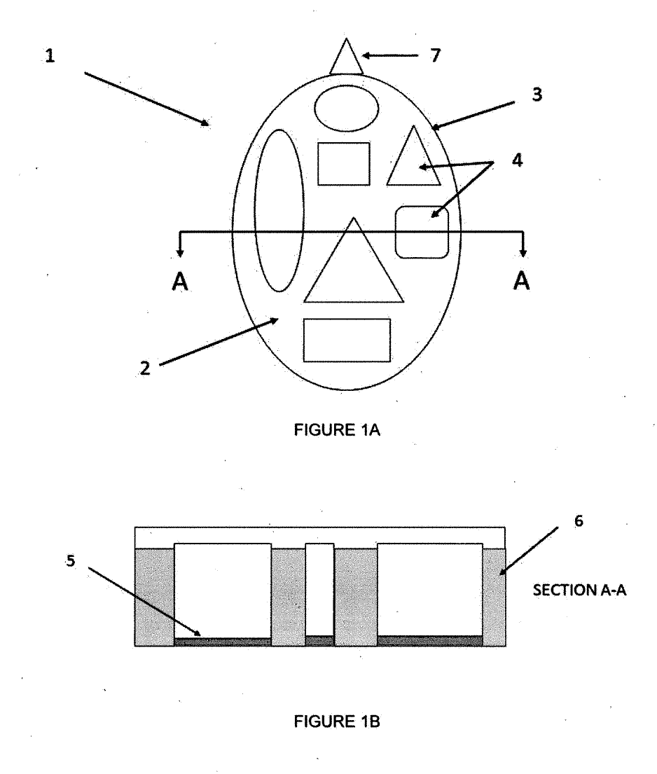

As shown generally in FIG. 1, a pendant 1 was produced by forming a generally oval sheet or substrate 2 of brass with .925 silver overlay, about 14×26 mm, with a raised bezel 3 about 3 mm high around the edge. A loop 7 may be provided to accommodate a chain, cord, or the like. Flattened ceramic tiles 4 of various sizes and colors were arranged in the area surrounded by the bezel and affixed to metal substrate 2 with adhesive 5 [Weldbond® universal adhesive]. Spaces between individual ceramic pieces ranged from about 3 to 5 mm wide., Note that in SECT A-A, the vertical dimension (i.e., thickness) has been exaggerated somewhat to better visualize the various elements.
A grout mixture 6 was formulated as follows: Powdered grout [black color, non-sanded grout, Tiny Tile Mosaics] was mixed with water according to manufacturer's directions. About 3 g of cremains were added to about 6 g of the grout (i.e., ˜33% cremains on a dry weight basis) and thoroughly mixed to a toothpaste-like consistency. The resulting mixture had a substantially black color and suitable workability to easily fill in the channels in the mosaic. After setting for about 2 minutes, the mosaic was cleaned and ready for use.

The commercial grout used in the foregoing example is available in black, white, and several other colors. Although Applicant prefers to use black in many cases, it will be appreciated that mixing cremains with white grout will typically create some shade of gray, depending on the quantities used. This may be put to artistic effect, if desired. For example, smaller batches with different quantities of cremains may be formulated and applied to different parts of the mosaic to form a gradation in the grout color from one area to the next. It will also be clear that the grout color may be selected in part based on the color(s) of the mosaic pieces, so that with darker pieces a lighter grout may be preferred and vice versa.

It will be understood that the amount of cremains added to the grout may vary over a significant range, limited primarily by the following considerations: 1. There must be sufficient binder material for the finished body to have adequate strength. 2. When using white grout and relying on the darker cremains to produce a desired range of off-white to gray colors, the amount of cremains will be dictated to some degree by the color desired, provided that the finished grout has adequate strength. 3. Depending on the particle size of the cremains, too large an amount might lead to a rough surface, poor workability, etc. These effects can be mitigated in part by routine ceramic processing techniques such as grinding the cremains, selecting a particular size fraction, adding dispersants, or other well-known methods. Applicant prefers that the grout contains an amount of cremains ranging from about 5% to about 50% (dry weight basis) and more preferably from about 10% to about 35% (dry weight basis).

It will be further understood that the grout may be treated after setting and cleaning using various conventional methods, such as the application of sealant to further strengthen the grout and make the item water resistant. Many suitable sealants are well known in the art.

In the preceding example, the substrate comprised brass with a sterling silver overlay. It will be understood that many metals are familiar in the art of jewelry making; these include gold, silver, platinum, copper, brass, steel, stainless steel, nickel, titanium, niobium, tantalum, and alloys and composites thereof. Alloys and composites include: 10-karat gold, 14-karat gold, sterling silver, coin silver, gold-plated and gold-filled metalware, rhodium-plated silver, nickel-plated stainless steel, “German silver” (typically 60Cu-20Ni-20Sn), etc.

### EXAMPLE

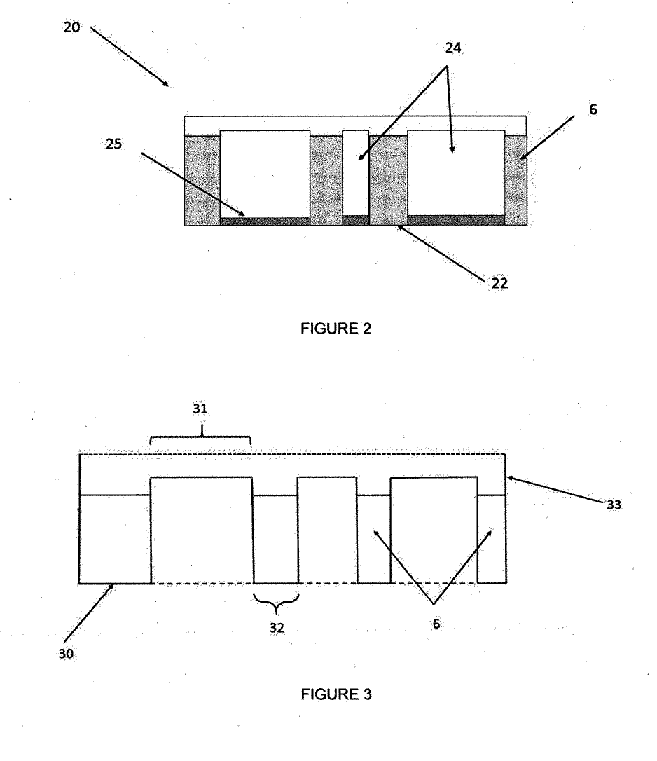

For a more elegant piece of jewelry, shown generally at 20 in FIG. 2, individual “tiles” 24 may be formed from thicker metal stock, and might be one or a number of different metals, such as gold, silver, copper, stainless steel, or brass. These pieces may be cut to any selected shapes. The metal substrate 22 may be copper, brass, sterling silver, etc. The individual metal tiles may be arranged into the desired pattern and then attached to substrate 22 by a braze or solder joint 25 by any suitable method, such as furnace brazing or hand brazing with a torch, using any conventional braze or solder composition appropriate for the metal(s) being used. The assembly may then be cleaned, pickled, polished, washed, and dried, after which the inventive grout mixture 6 is applied.

Note that in the drawings, for convenience and clarity, the individual tiles are shown as having generally uniform thicknesses and the bezel is shown as extending slightly above the level of the grout. It will be understood that tiles of any selected thickness may be used. For example, thicker tiles may be used in the center and thinner tiles at the periphery, and the thicker tiles may extend above the height of the bezel. In such cases, the grout may preferably be substantially flush with the height of the bezel and become gradually thicker toward the center to provide a generally convex surface to conform to the varying tile thicknesses.

It will be appreciated that the most common type of “mosaic” art involves ceramic, glass, or stone pieces set in a grout that is typically based on a cementitious binder involving water and a phase such as Portland cement or plaster of Paris. The water first mixes with the cementitious material to form a thixotropic or plastic mixture that has appropriate rheological properties to flow completely into the spaces to be filled. Then, upon setting for some period of time, a chemical reaction occurs that creates a rigid, although microscopically porous, mass having sufficient strength to serve the desired purpose. Alternatively, once the individual pieces or tiles are fixed in place, a polymer-based grout composition may be used to fill in the gaps between tiles, as described more fully in the following example.

### EXAMPLE

An item of jewelry could be constructed by affixing a plurality of individual stones to a substrate. A mixture of a thermosetting polymer (e.g, a two-part epoxy) could be blended with selected fillers, such as ceramic powder, carbon black, marble dust, etc., an amount of cremains added, and then this mixture could be filled in around the stones. After hardening, the composite object could be mounted on a dop and ground and polished to a desired size and shape, just as a single larger stone might be, to form a large, composite cabochon suitable for mounting in a piece of jewelry.

The method described in the preceding example could also be used to produce a larger amount of material, if more material were needed to create a set of jewelry, a larger ornamental object, etc.

### EXAMPLE

A mixture of thermosetting polymer, selected filler materials, and cremains could be formulated. A quantity of stones (e.g., gem or lapidary rough, small agates, etc.) may be added in such an amount that the amount of polymer mixture is sufficient to fill all of the interstitial space between the individual stones. The amount of polymer needed may be minimized by proper selection of the size distribution of the stones, as well as by agitating or vibrating the mixture, as is well known in the art. The mixture of stones and binder would be placed in a mold of suitable dimensions (a generally rectangular prism would be preferable in many cases) and the binder would be cured to form a strong, solid composite mass. The mass could be sliced with a diamond saw to form slabs suitable for grinding and polishing into cabochons for jewelry or polished in slab form to make a small box or other decorative item.

Several of the foregoing examples contemplate employing the inventive grout in a true mosaic art technique in which discrete tiles are separated by grout lines. One can also simulate the appearance of a mosaic using a stamped or formed metal substrate, as described in the following example.

### EXAMPLE

As shown schematically in cross section in FIG. 3, a metal sheet 30 is formed with raised areas 31 separated by channels 32, and a bezel 33 around the edge. Grout 6 containing cremains may then be worked into the channels 32 to give the appearance of a mosaic design when viewed from the front.

Metal sheet 30 may be a precious metal alloy, such as gold, gold-plated, or gold-filled materials, sterling silver, rhodium-plated silver, etc. Alternatively, it may be stainless steel, with either a polished or matte finish, or a more exotic material such as a refractory metal (Ti, Nb, Ta, etc.) that can be treated by anodizing or other methods to develop a colorful surface effect or tarnish for further artistic effects. Sheet 30 may also comprise an alloy such as pewter, which is easily formable and also easily castable to produce a shape with raised areas simulating mosaic tiles.

The inventive grout may be further employed to make other memorial items in a modification of the foregoing Example in which a preformed object (typically metal) is provided with a depresses are, into which the grout is set so as to provide a contrasting pattern or inlay, in a design which may be specific to a particular situation, as described in the following Examples.

### EXAMPLE

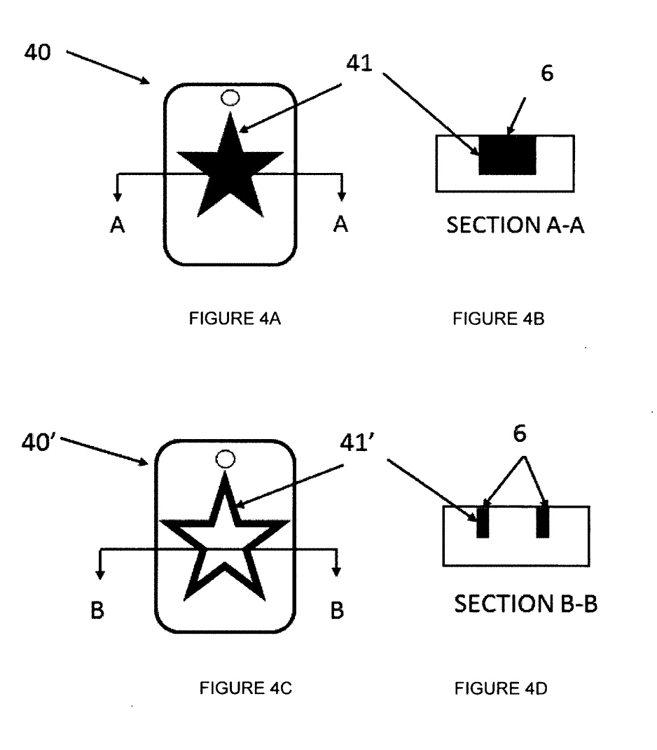

As shown schematically in FIG. 4A, a ring or pendant 40 may be formed, e.g., of sterling silver and having a depression 41 in the shape of a loved one's initials, a stylized heart, a star (e.g., for a military veteran), or other appropriate shape. Depression 41 may be formed by machining, casting, stamping, or other well-known metalworking process.
The user would then prepare the grout mixture including cremains, pack grout 6 into depression 41, then smooth and clean the top surface. After final setting/drying, a sealant may optionally be applied.
It will be appreciated that depression 41 may contain various features to provide a more secure bond to the grout. These may include ridges, grooves, posts, protuberances, etc., and the bottom of the depression, or selective undercutting of the side walls. Alternatively, as shown schematically in FIG. 46, the design may be divided into a series of channels 41′, which would retain the overall visual shape but would contain grout 6 more securely than would the more expansive depression 41.

### EXAMPLE

In a veterinary setting, a memorial object might have a preformed depression in the shape of a cat's head, a paw print, a profile rendering of a particular breed of dog, or some other visual device to recall the pet. As before, the user would mix the grout and cremains, fill the inlay area, and thereby create an attractive memorial item.

It will be understood that the items described in the two foregoing Examples might be of a suitable size and form factor to be used as jewelry. Alternatively, they might be substantially larger for use as a paperweight, a set of bookends, or other decorative object. For such uses, pewter will be particularly preferable in many cases because of its substantial mass, ease of workability, and lower cost relative to materials such as sterling silver.

The skilled artisan will appreciate that according to another aspect of the invention, many of the components may be provided together to form a kit that may contain a preformed substrate, a selection of various tiles, adhesive, and a package of grout. A measuring spoon and instructions may further be included to enable a user to mix an appropriate ratio of grout, water, and cremains. Thus, a user can have the freedom to exercise some degree of artistic control over the finished object, while at the same time the user need not have any specialized training or equipment in order to create an attractive memorial object. Alternatively, the kit may be prefabricated so that all the user needs to do is mix the grout and apply it to the piece. This mode may be used either in the case of a metal object having channels or depressions into which the inventive grout is applied, or in the case of a mosaic, the kit may have the mosaic pieces already affixed to the substrate in a predetermined pattern. Such a kit could be mass-produced using standard pick-and-place methods as are well known in the art of electronic assembly.

Although in several of the foregoing Examples, the metal substrate is described as a sheet, it will be appreciated that the invention is not limited to “sheet metal” per se, i.e., metallic sheet material produced by rolling or other mechanical working. Specifically, an object of a selected size and shape, having a working surface surrounded by a raised bezel, may alternatively be produced by investment casting or any other suitable process as are well known in the metalworking arts. The bezel may be formed as an integral part of the original metal structure by casting, stamping, deep-drawing, etc., or it may be formed by attaching a separate metal strip by soldering or brazing. It will be further understood that, although the area to which the mosaics are attached is shown in the drawings as being substantially flat, the surface may equally well be convex to some degree, e.g., when forming a bracelet or other generally curved object.

In some of the foregoing Examples, mosaic pieces were affixed to the substrate by adhesive bonding before the application of the inventive grout. It will be appreciated, however, that in some cases the grout itself may further perform the bonding function. For example, if the bezel provides a sufficiently deep volume, the entire volume may be substantially filled with grout and then the individual tiles may be forced down into the wet grout, leaving a thin layer of grout under the tiles to serve as the bonding agent. This approach might be more suitable for tiles that have a generally rough underside, so that the grout will adhere sufficiently, whereas a separate (and preferably stronger) adhesive bonding material may be more suitable for smooth objects such as glass tiles or beads.

I claim:

1. A decorative memorial object comprising:
a metal substrate having a bottom surface, a top surface, and a bezel projecting upwardly from said top surface and defining an area thereon;
a plurality of mosaic pieces arranged within the area defined by said bezel and affixed to the top surface of said substrate; and,
a grout material disposed in the interstices between the individual mosaic pieces and between said mosaic pieces and said bezel, said grout material comprising a binder and a selected quantity of cremains of the individual being memorialized, so that said cremains are visible on the surface and thereby form part of the mosaic design.

2. The decorative object of claim 1 wherein said metal substrate comprises a material selected from the group consisting of: gold, silver, platinum, rhodium, copper, brass, steel, stainless steel, nickel, titanium, niobium, tantalum, pewter, and alloys and composites thereof.

3. The decorative object of claim 1 wherein said mosaic pieces are affixed to said substrate by adhesive bonding.

4. The decorative object of claim 1 wherein said mosaic pieces are affixed to said substrate by a process selected from the group consisting of: soldering and brazing.

5. The decorative object of claim 1 wherein said grout material contains an amount of cremains ranging from about 5% to about 50% on a dry weight basis.

6. The decorative object of claim 1 wherein said grout material comprises a thermosetting polymer containing an amount of cremains ranging from about 5% to about 50% on a dry weight basis.

7. The decorative object of claim 1 further comprising a sealant applied to the surface of said grout.

8. A method for making a decorative memorial item comprises the steps of:
forming a metal substrate into a selected shape, with a raised bezel around the periphery of an area thereof;
placing mosaic pieces in a selected arrangement within the area defined by the bezel;
fixedly attaching said mosaic pieces to said metal substrate in said selected arrangement;
making a grout mixture containing a binder, a filler, and a selected quantity of cremains of the subject being memorialized;
applying said grout mixture to fill the spaces between individual mosaic pieces and between said mosaic pieces and said raised bezel; and,
cleaning the finished mosaic to remove excess grout.

9. The method of claim 8 wherein said metal substrate comprises a material selected from the group consisting of: gold, silver, platinum, rhodium, copper, brass, steel, stainless steel, nickel, titanium, niobium, tantalum, pewter, and alloys and composites thereof.

10. The method of claim 8 wherein said mosaic pieces are affixed to said substrate by adhesive bonding.

11. The method of claim 8 wherein said mosaic pieces are affixed to said substrate by a process selected from the group consisting of: soldering and brazing.

12. The method of claim 8 wherein said grout material contains an amount of cremains ranging from about 5% to about 50% on a dry weight basis.

13. The method of claim 8 wherein said grout material comprises a thermosetting polymer containing an amount of cremains ranging from about 5% to about 50% on a dry weight basis.

14. The method of claim 8 further comprising the step of:
applying a sealant to the surface of said grout.

15. A decorative grout for making a memorial item comprising:
a filler material of a selected color;
a binder phase; and,
a selected amount of cremains that will be visible on the surface after the grout has hardened.

16. The decorative grout of claim 15 wherein said binder phase comprises a hydraulic cementitious material selected from the group consisting of: plaster of Paris, and Portland cement.

16. The decorative grout of claim 15 wherein said binder phase comprises a thermosetting polymer.

17. The decorative grout of claim 15 wherein said grout material contains an amount of cremains ranging from about 5% to about 50% on a dry weight basis.

18. The decorative grout of claim 15 further comprising a sealant to make said grout substantially water-resistant.
